(19) United States
(12) Patent Application Publication
(10) Pub. No.: US 2025/0023471 A1
(43) Pub. Date: Jan. 16, 2025

(54) SEMICONDUCTOR INTEGRATED CIRCUIT DEVICE, ELECTRICAL APPARATUS, AND VEHICLE

(71) Applicant: ROHM CO., LTD., Kyoto (JP)

(72) Inventor: Hiroaki ASAZU, Kyoto (JP)

(21) Appl. No.: 18/764,680

(22) Filed: Jul. 5, 2024

(30) Foreign Application Priority Data
Jul. 11, 2023 (JP) 2023-113601

(51) Int. Cl. H02M 3/158; B60R 16/03

(52) U.S. Cl. CPC H02M 3/158; B60R 16/03

(57) ABSTRACT

A semiconductor integrated circuit device forms at least a portion of a power supply device configured to convert an input voltage into an output voltage. The semiconductor integrated circuit device includes: a memory configured to store a plurality of settings regarding a plurality of types of internal parameters; a receiver configured to receive an instruction transmitted from outside the semiconductor integrated circuit device; and a controller configured to select and enable one of the plurality of settings on the basis of the instruction.

### CROSS-REFERENCE TO RELATED APPLICATIONS

This nonprovisional application claims priority under 35 U.S.C. § 119 (a) on Patent Application No. 2023-113601 filed in Japan on Jul. 11, 2023, the entire contents of which are hereby incorporated by reference.

### BACKGROUND OF THE INVENTION

### 1. Technical Field

The disclosure herein relates to a semiconductor integrated circuit device, an electrical apparatus, and a vehicle.

### 2. Description of Related Art

Conventionally, various power supply devices have been developed supplying power supply voltages to processors (e.g., refer to Japanese Patent Application Laid-Open Publication No. 2016-24561).

### BRIEF DESCRIPTION OF THE DRAWINGS

FIG. 1 is a diagram illustrating a schematic configuration of an electrical apparatus according to an embodiment.

FIG. 2 is a diagram illustrating an example of a plurality of types of setting values of internal parameters respectively corresponding to a plurality of settings.

FIG. 3 is a diagram conceptually illustrating an example of a data table illustrating a relationship between settings and states of the setting.

FIG. 4 is a diagram conceptually illustrating another example of the data table illustrating the relationship between setting and states of the setting.

FIG. 5 is a diagram illustrating power efficiency characteristics in each of the settings.

FIG. 6 is a diagram conceptually illustrating an example of a data table illustrating a relationship between a maximum load current range and each setting.

FIG. 7 is an external view of a vehicle.

### DETAILED DESCRIPTION

### <Electrical Apparatus>

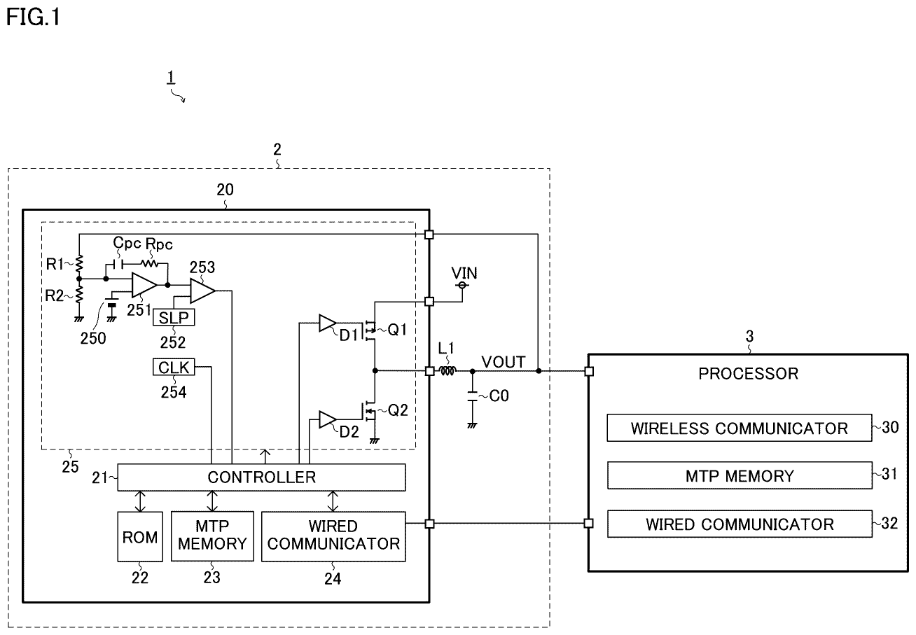

FIG. 1 is a diagram illustrating a schematic configuration of an electrical apparatus according to an embodiment. The electrical apparatus 1 includes a power supply device 2 and a processor 3.

The power supply device 2 includes a semiconductor integrated circuit device 20, an inductor L1, and an output capacitor C0. In the present embodiment, the power supply device 2 is a step-down switching power supply device configured to convert an input voltage VIN into an output voltage VOUT lower than the input voltage VIN, but may be a power supply device other than the step-down switching power supply device. As the power supply devices other than the step-down switching power supply device, there can be listed a linear power supply device, a step-up switching power supply device, a step-down/step-up switching power supply device, and the like, for example.

The semiconductor integrated circuit device 20 includes a controller 21, a Read Only Memory (ROM) 22, a Multiple-Time Programmable (MTP) memory 23, a wired communicator 24, and an analog circuit 25.

The analog circuit 25 includes a reference voltage source 250, an error amplifier 251, a slope circuit 252, a Pulse Width Modulation (PWM) comparator 253, a clock circuit 254, resistors R1, R2, and Rpc, a capacitor Cpc, drivers D1 to D2, a P-channel Metal Oxide Semiconductor (PMOS) transistor Q1, and an N-channel Metal Oxide Semiconductor (NMOS) transistor Q2.

The input voltage VIN is applied to a source of the PMOS transistor Q1. A source of the NMOS transistor Q2 is connected to a ground potential. A pulsed switch voltage is generated at each drain of the PMOS transistor Q1 and the NMOS transistor Q2 by complementary switching operations of the PMOS transistor Q1 and the NMOS transistor Q2.

The drain of the PMOS transistor Q1 and the drain of the NMOS transistor Q2 are connected to a first end of the inductor L1. A second end of the inductor L1 is connected to a first end of the output capacitor C0. A second end of the output capacitor C0 is connected to the ground potential. The inductor L1 and the output capacitor C0 generate the output voltage VOUT obtained by smoothing the pulsed switch voltage.

The resistors R1 and R2 divide the output voltage VOUT. The error amplifier 251 outputs an error signal according to a difference between a divided voltage of the output voltage VOUT and a reference voltage output from the reference voltage source 250. The capacitor Cpc and the resistor Rpc compensate a phase of the error amplifier 251.

The PWM comparator 253 compares the error signal output from the error amplifier 251 with a slope voltage output from the slope circuit 252, and outputs a set signal that is a result of the comparison. The set signal output from the PWM comparator 253 is a PWM signal with a duty according to the output voltage VOUT. The clock circuit 254 outputs a reset signal that is a clock signal.

The controller 21 complementarily switches the PMOS transistor Q1 and the NMOS transistor Q2 on the basis of the set signal and the reset signal. A drive signal for the PMOS transistors Q1 output from the controller 21 is power-amplified by the driver D1 and then is supplied to a gate of the PMOS transistor Q1. A drive signal for the NMOS transistors Q2 output from the controller 21 is power-amplified by the driver D2 and then is supplied to a gate of the NMOS transistor Q2.

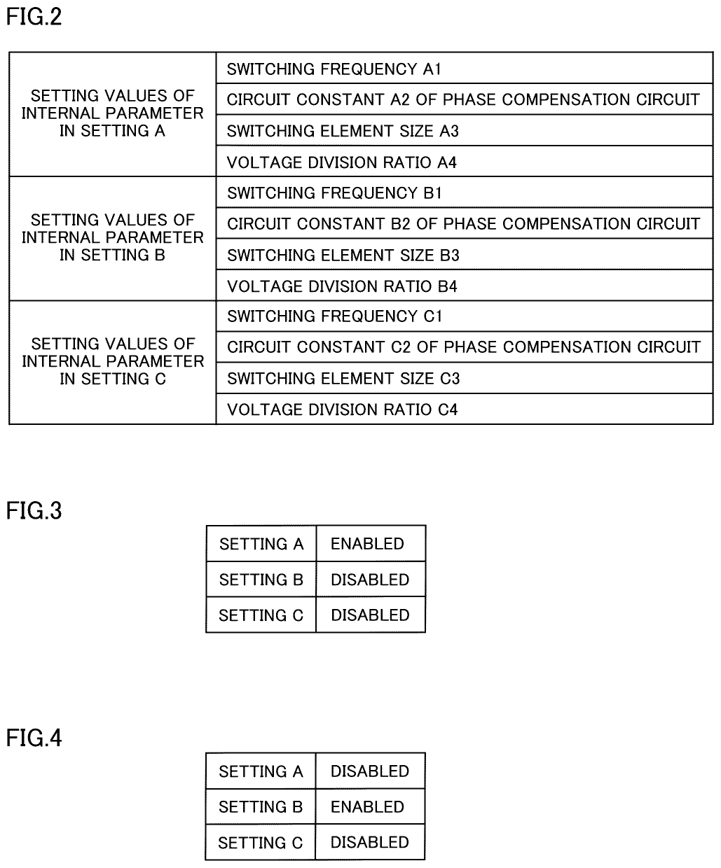

The ROM 22 stores a plurality of types of setting values of internal parameters respectively corresponding to a plurality of settings. FIG. 2 is a diagram illustrating an example of the plurality of types of setting values of internal parameters respectively corresponding to the plurality of settings. In the present embodiment, the ROM 22 stores setting values illustrated in FIG. 2.

The ROM 22 stores a switching frequency A1, a circuit constant A2 of the phase compensation circuit, a switching element size A3, and a voltage division ratio A4, as the setting values of the internal parameter in setting A. Similarly, the ROM 22 stores a switching frequency B1, a circuit constant B2 of the phase compensation circuit, a switching element size B3, and a voltage division ratio B4, as the setting values of the internal parameter in setting B. Similarly, the ROM 22 stores a switching frequency C1, a circuit constant C2 of the phase compensation circuit, a switching element size C3, and a voltage division ratio C4, as the setting values of the internal parameter in setting C. It is to be noted that the switching frequency, the circuit constant of the phase compensation circuit, the switching element size, and the voltage division ratio are merely in exemplification of the internal parameter. The internal parameter may include setting value(s) other than the switching frequency, the circuit constant of the phase compensation circuit, the switching element size, and the voltage division ratio. The internal parameter includes, for example, an overcurrent detection threshold for an overcurrent protective function, an overvoltage detection threshold for an overvoltage protective function, and the like, other than the switching frequency, the circuit constant of the phase compensation circuit, the switching element size, and the voltage division ratio.

The multiple-time programmable memory 23 stores the plurality of settings regarding the plurality of types of internal parameters. Moreover, the multiple-time programmable memory 23 stores of which the plurality of settings is enabled. FIG. 3 is a diagram conceptually illustrating an example of a data table illustrating a relationship between settings and states of the setting. In FIG. 3, the number of settings is three, i.e., the setting A, the setting B, and the setting C, but the number thereof is not be limited to three and may be two or four or more.

When the multiple-time programmable memory 23 stores the data table illustrated in FIG. 3, the setting A is enabled and the setting B and the setting C are disabled. When the setting A is enabled, the controller 21 controls the analog circuit 25 so that the analog circuit 25 is in accordance with the setting A.

Specifically, when the setting A is enabled, the controller 21 controls a frequency of the slope voltage output from the slope circuit 252 and a clock frequency of the clock circuit 254 so that the switching frequency is set to the A1.

Moreover, when the setting A is enabled, the controller 21 controls the capacitor Cpc and the resistor Rpc so that the circuit constant of the phase compensation circuit configured with the capacitor Cpc and the resistor Rpc is set to the A2. The capacitor Cpc has, for example, a configuration in which a plurality of series circuits of capacitors and switches are connected in parallel to one another. An electrostatic capacity value of the capacitor Cpc is varied by controlling each switch by the controller 21. The resistor Rpc has, for example, a configuration in which a plurality of series circuits of resistors and switches are connected in parallel to one another. A resistance value of the resistor Rpc is varied by controlling each switch by the controller 21.

Moreover, when the setting A is enabled, the controller 21 controls the PMOS transistor Q1 and the NMOS transistor Q2 so that each size of the PMOS transistor Q1 and the NMOS transistor Q2, which are switching elements, is set to the A3. The PMOS transistor Q1 has, for example, a configuration in which a plurality of series circuits of PMOS transistors and switches are connected in parallel to one another. The size of the PMOS transistor Q1 is varied by controlling each switch by the controller 21. The NMOS transistor Q2 has, for example, a configuration in which a plurality of series circuits of NMOS transistors and switches are connected in parallel to one another. The size of the NMOS transistor Q2 is varied by controlling each switch by the controller 21.

Moreover, when the setting A is enabled, the controller 21 controls the resistor R1 so that a voltage division ratio of the resistors R1 and R2 is set to the A4. The resistor R1 has, for example, a configuration in which a plurality of series circuits of resistors and switches are connected in parallel to one another. A resistance value of the resistor R1 is varied by controlling each switch by the controller 21.

The wired communicator 24 executes wired communication with the wired communicator 32 in the processor 3. The wired communication between the wired communicator 24 and the wired communicator 32 may be, for example, Inter-Integrated Circuit (I2C) communication or Serial Peripheral Interface (SPI) communication, or may also be wired communications other than the I2C communication or the SPI communication.

The wired communicator 24 receives an instruction transmitted from the wired communicator 32 in the processor 3. The controller 21 selects one setting of the plurality of settings on the basis of the instruction received by the wired communicator 24 and enables the selected setting.

For example, when an instruction to enable the setting B is transmitted from the wired communicator 32 in the processor 3 to the wired communicator 24 while the multiple-time programmable memory 23 stores the data table illustrated in FIG. 3, the controller 21 rewrites the contents stored in the multiple-time programmable memory 23 from contents of the data table illustrated in FIG. 3 to contents of the data table illustrating in FIG. 4. When the multiple-time programmable memory 23 stores the data table illustrated in FIG. 4, the setting B is enabled and the setting A and the setting C are disabled.

The processor 3 may be, for example, a System on a Chip (SoC), a Micro Controller Unit (MCU), or the like. The processor 3 includes a wireless communicator 30, a multiple-time programmable memory 31, and a wired communicator 32. The processor 3 uses the output voltage VOUT from the power supply device 2 as a power supply voltage to execute software stored in the multiple-time programmable memory 31.

In the processor 3, the software can be updated through Over The Air (OTA) technology. In other words, in the processor 3, the software can be updated through wireless communication executed by the wireless communicator 30 with a software update information provider (e.g., a server). It is to be noted that, in the processor 3, instead of the wireless communication executed by the wireless communicator 30, or in addition to the wireless communication executed by the wireless communicator 30, the software may be able to be updated through wired communication executed by the wired communicator 32 with a software update information provider (e.g., personal computer wired-connected to the electrical apparatus 1).

The processor 3 transmits an instruction to the semiconductor integrated circuit device 20 in response to the update of the software. More specifically, the wired communicator 32 in the processor 3 transmits the instruction to the wired communicator 24 in the semiconductor integrated circuit device 20 in response to the update of the software. Consequently, the semiconductor integrated circuit device 20 can change the settings at appropriate timing.

It is to be noted that the processor 3 does not always need to transmit the instruction to the semiconductor integrated circuit device 20 for every update of the software. When the functionality of the processor 3 is enhanced by updating the software and thereby changing of the settings of the semiconductor integrated circuit device 20 is required, the processor 3 should just transmit the instruction to the semiconductor integrated circuit device 20 in response to the update of the software.

As described above, the semiconductor integrated circuit device 20 changes the settings regarding the plurality of types of internal parameters on the basis of the instruction from outside the semiconductor integrated circuit device 20 (in the present embodiment, the processor 3). On the other hand, the setting values of the internal parameters cannot be changed freely and individually even by the instruction from outside the semiconductor integrated circuit device 20 (in the present embodiment, the processor 3). In other words, for outside the semiconductor integrated circuit device 20 (in the present embodiment, the processor 3), the internal structure of the semiconductor integrated circuit device 20 is a black box, and there is no other way to select one of the plurality of settings (in the present embodiment, the setting A, the setting B, and the setting C) stored in the multiple-time programmable memory 23 in the semiconductor integrated circuit device 20. Accordingly, the semiconductor integrated circuit device 20 can appropriately change the settings regarding the plurality of types of internal parameters.

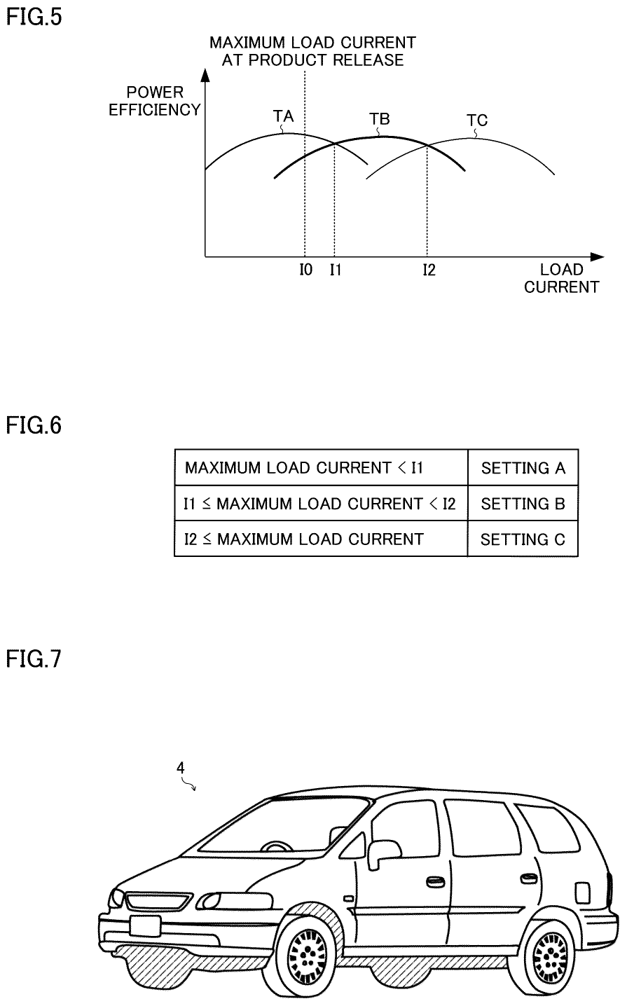

A manufacturer of the semiconductor integrated circuit device 20 discloses, to a manufacturer of the electrical apparatus 1, the plurality of setting (in the present embodiment, the setting A, the setting B, and the setting C) stored in the multiple-time programmable memory 23 and power efficiency characteristics of each setting. FIG. 5 is a diagram illustrating power efficiency characteristics in each of the settings. The horizontal axis in FIG. 5 represents a load current of the power supply device 2 (power consumption of the processor 3). The vertical axis in FIG. 5 represents power efficiency of the power supply device 2. FIG. 5 depicts power efficiency characteristics TA in the setting A, power efficiency characteristics TB in the setting B, and power efficiency characteristics TC in the setting C.

For example, when a maximum load current of the electrical apparatus 1 (maximum current consumption of the processor 3) at product release is a current 10 illustrated in FIG. 5, the semiconductor integrated circuit device 20 at the time of product release of the electrical apparatus 1 should just be set to the setting A. Then, in response to the update of the software, the setting for the semiconductor integrated circuit device 20 should just be changed from the setting A to the setting B or the setting C on the basis of the instruction from outside the semiconductor integrated circuit device 20.

In the above-described embodiment, the instruction from outside the semiconductor integrated circuit device 20 includes content that directly instructs to select any one of the setting A, the setting B, and the setting C as the setting for the semiconductor integrated circuit device 20.

The instruction from outside the semiconductor integrated circuit device 20 may include information regarding the maximum load current of the power supply device 2 instead of including the content that directly instructs to select any one of the setting A, the setting B, and the setting C as the setting for the semiconductor integrated circuit device 20.

When the specification that the instruction from outside the semiconductor integrated circuit device 20 includes such information regarding the maximum load current of the power supply device 2 is adopted into the electrical apparatus 1, the ROM 22 may be configured to store, for example, the data table illustrated in FIG. 6. FIG. 6 is a diagram conceptually illustrating an example of a data table illustrating a relationship between a maximum load current range for the power supply device 2 and each setting. The controller 21 may merely rewrite the contents stored in the multiple-time programmable memory 23 on the basis of the instruction from outside the semiconductor integrated circuit device 20 and the data table illustrated in FIG. 6.

### Application Example

The above-described electrical apparatus 1 is mounted on, for example, a vehicle 4 illustrated in FIG. 7. Namely, the vehicle 4 includes the electrical apparatus 1. Examples of the electrical apparatus 1 mounted on the vehicle 4 include an infotainment electrical apparatus, an Advanced Driver-Assistance Systems (ADAS) electrical apparatus, an automatic driving electrical apparatus, and the like.

It is to be noted that the above-described electrical apparatus 1 is not limited to such an in-vehicle electrical apparatus. The above-described electrical apparatus 1 may also be mounted in, for example, home electronics or the like.

### <Others>

In addition to the embodiments described above, the configurations disclosed herein can be modified in various ways without departing from the gist of the disclosure. The above-described embodiments are illustrative and not restrictive in all aspects. The technical scope disclosed herein is defined by the appended claims rather than by the description of the above-described embodiments, and all modifications that fall within metes and bounds of the claims, or equivalence of such metes and bounds thereof are therefore intended to be embraced by the claims.

### <Additional Remarks>

The following is an additional remark of the present disclosure for which the specific configuration examples are illustrated in the embodiments.

In a first configuration, a semiconductor integrated circuit device (20) disclosed herein forms at least a portion of a power supply device (2) configured to convert an input voltage into an output voltage. The semiconductor integrated circuit device includes: a memory (23) configured to store a plurality of settings regarding a plurality of types of internal parameters; a receiver (24) configured to receive an instruction transmitted from outside the semiconductor integrated circuit device; and a controller (21) configured to select one of the plurality of settings on the basis of the instruction and to enable the selected setting.

The semiconductor integrated circuit device according to the above-described first configuration changes the settings regarding the plurality of types of internal parameters on the basis of an instruction from outside the semiconductor integrated circuit device. On the other hand, the setting values of the internal parameters cannot be changed freely and individually even by the instruction from outside the semiconductor integrated circuit device. In other words, for outside the semiconductor integrated circuit device, the internal structure of the semiconductor integrated circuit device is a black box, and there is no other way to select one of the plurality of settings stored in the memory in the semiconductor integrated circuit device. Accordingly, the semiconductor integrated circuit device 20 can appropriately change the settings regarding the plurality of types of internal parameters. Consequently, the semiconductor integrated circuit device according to the first configuration can solve the problem that conventionally the internal parameters of the power supply device are not in the optimal state at the time of product release.

The semiconductor integrated circuit device according to the above-described first configuration may include a second configuration, in which the memory is a multiple-time programmable memory and is configured to store of which the plurality of settings is enabled.

The semiconductor integrated circuit device including the above-described first or second configuration may include a third configuration further including a read-only memory (22) configured to store the plurality of types of setting values of internal parameters respectively corresponding to the plurality of settings.

The semiconductor integrated circuit device according to any one of the above-described first to third configurations may include a fourth configuration, in which the receiver is configured to receive the instruction through wired communication.

The semiconductor integrated circuit device according to any one of the above-described first to fourth configurations may include a fifth configuration, in which the instruction includes information regarding a maximum load current of the power supply device.

In a sixth configuration, an electrical apparatus disclosed herein includes: a power supply device (2); and a processor (3) configured to execute software using an output voltage of the power supply device as a power supply voltage, wherein the power supply device includes the semiconductor integrated circuit device according to any one of the above-described first to fifth configurations, and the processor is configured to make it possible to update the software through communication.

The electrical apparatus according to the above-described sixth configuration may include a seventh configuration, in which the update of the software is executed through wireless communication.

The electrical apparatus according to the above-mentioned sixth or seventh configuration may include an eighth configuration, in which the processor is configured to transmit the instruction to the semiconductor integrated circuit in response to the update of the software.

In a ninth configuration, a vehicle (4) disclosed herein includes the electrical apparatus according to any one of the above-mentioned sixth to eighth configurations.

What is claimed is:

1. A semiconductor integrated circuit device forming at least a portion of a power supply device, the power supply device configured to convert an input voltage into an output voltage, the semiconductor integrated circuit device comprising:
a memory configured to store a plurality of settings regarding a plurality of types of internal parameters;
a receiver configured to receive an instruction transmitted from outside the semiconductor integrated circuit device; and
a controller configured to select one of the plurality of settings on the basis of the instruction and to enable the selected setting.

2. The semiconductor integrated circuit device according to claim 1,
wherein the memory, which is a multiple-time programmable memory, is configured to store of which the plurality of settings is enabled.

3. The semiconductor integrated circuit device according to claim 1, further comprising:
a read-only memory configured to store the plurality of types of setting values of internal parameters respectively corresponding to the plurality of settings.

4. The semiconductor integrated circuit device according to claim 1,
wherein the receiver is configured to receive the instruction through wired communication.

5. The semiconductor integrated circuit device according to claim 1,
wherein the instruction includes information regarding a maximum load current of the power supply device.

6. An electrical apparatus comprising:
a power supply device; and
a processor configured to execute software using an output voltage of the power supply device as a power supply voltage,
wherein the power supply device includes the semiconductor integrated circuit device according to claim 1, and
the processor is configured to make it possible to update the software through communication.

7. The electrical apparatus according to claim 6,
wherein the update of the software is executed through wireless communication.

8. The electrical apparatus according to claim 6,
wherein the processor is configured to transmit the instruction to the semiconductor integrated circuit in response to the update of the software.

9. The electrical apparatus according to claim 7,
wherein the processor is configured to transmit the instruction to the semiconductor integrated circuit in response to the update of the software.

10. A vehicle comprising:
the electrical apparatus according to claim 6.

11. A vehicle comprising:
the electrical apparatus according to claim 7.

12. A vehicle comprising:
the electrical apparatus according to claim 8.

13. A vehicle comprising:
the electrical apparatus according to claim 9.
